(19) United States
(12) Patent Application Publication
(10) Pub. No.: US 2013/0292416 A1
(43) Pub. Date: Nov. 7, 2013

(54) DEVICE AND METHOD FOR DISTRIBUTING POWDER

(71) Applicant: Henk Van De Hee, Ede (NL)

(72) Inventor: Henk Van De Hee, Ede (NL)

(73) Assignee: TEIJIN ARAMID B.V., Arnhem (NL)

(21) Appl. No.: 13/980,761

(22) PCT Filed: Jan. 20, 2012
(86) PCT No.: PCT/EP12/50822

§ 371 Date: Jul. 19, 2013

(30) Foreign Application Priority Data
Jan. 24, 2011 (EP) 1151786.8

(51) Int. Cl. B67D 3/00

(52) U.S. Cl. CPC B67D 3/0058
USPC 222/129

(57) ABSTRACT

A double hopper system is disclosed. The double hopper system includes, a first hopper and a second hopper. The first hopper has a first and a second opening, and the second hopper is arranged above the second opening of the first hopper and extends into the second opening of the first hopper. The first opening of the first hopper has a predetermined length and a distribution area, and the second hopper is movably arranged with respect to the first hopper, such that the second hopper is movable over at least ¾ of the length of the first opening of the first hopper.

### FIELD OF THE INVENTION

The invention pertains to a double hopper system. The invention pertains also to a method for distributing material using the double hopper system.

### BACKGROUND

Double hopper systems with a material refilling mechanism are well known in the prior art. In document DE 1 611 317 for example a powder container with a storage container is disclosed. The storage container extends into the powder container and contains powder for refilling the powder container. The storage container is inside the powder container movably arranged, whereby the movement occurs mainly in a vertical direction.

In document DE 25 41 972 a powder container and a refill container are disclosed. The powder container is placed inside the refill container and both containers are connected with each other via one refill means. Due to the refill means powder of the refill container can enter the powder container. A first embodiment for the refill means is a movable sleigh, which conveys the powder into the powder container.

Both mentioned documents have the disadvantage that the refilling powder enters the powder container in restricted areas. Due to this the powder level in the powder container is inhomogeneous. Due to the inhomogeneous powder level, different pressures occur locally (via gravity) at the powder in the powder container, which results in inhomogeneous density and distribution of the powder.

WO 2010/108702 describes a distributor for e.g. cinder which comprises an upper and a lower distribution stage. The upper distribution stage consists of a hopper with an internal spreading device. The lower distribution stage contains also a divider for the bulk material. WO 2010/108702 aims to spread fine-grained bulk material evenly on rectangular surfaces.

### BRIEF SUMMARY OF THE INVENTION

The aim of this invention is to create a double hopper system, which has a homogenous and constantly repeatable powder density and distribution over the entire distribution area and over the entire distribution time.

The aim is achieved by a double hopper system with the features of claim 1.

The first and the second hopper contain material. Preferably the first and the second hopper contain powder and more preferred grained powder. In the following description, the words “material”, “powder” “grained powder” and “grained material” are used synonymously.

Due to the fact that the second hopper is moveably arranged over at least ¾ of the length of the first opening of the first hopper (leaving opening), the powder is homogenously refilled over the length of this opening and therefore over the total length of the powder level surface. Due to this, the unit pressure in the first hopper is homogenous. A constant refill guarantees therefore a homogenous powder distribution by the first opening of the first hopper; this means a constant powder amount over the distribution area of the first opening. As a result, a belt receives a very homogenous powder distribution especially regarding aerial weight and the density from the double hopper system.

“Moveably arranged” means that at least a sideface of the second hopper can move along the distance of the length of the first opening of the first hopper until the sideface comes into contact with one sideface of the first hopper or a separate stop mechanism. Moveably arranged over at least ¾ of the total length means, that this sideface of the second hopper can move over at least ¾ of the total length of the first opening of the first hopper. Preferably, the second hopper is moveably arranged over ⅚ and most preferred over the total length of the first opening of the first hopper.

Preferably, the movement of the second hopper occurs in a plane parallel to the distribution area. This means that the second hopper moves in horizontal direction without a vertical movement and the distribution area of the second hopper is horizontal beneath the second hopper where the first hopper is located. In contrast to document DE 1 611 317 (FIG. 2), the powder falls therefore without large differences of the remaining powder level in the first hopper. In one movement step of the second hopper (i.e., the second hopper moves along the length of the first opening of the first hopper and back) the powder level decreases continuously, because powder flows continuously out of the first opening of the first hopper. However, the powder level in the first hopper at a time t*_{N} and a position l*_{N} is constant in comparison with the powder level in the first hopper at the time t*_{N+1} and the position l*_{N+1} whereby N is the number of movement steps and l* is a constant position of the second hopper along the length l and t* is a constant point in time during this movement step. Partial or full compaction of powder in the first hopper as result of adding refilling powder can be avoided or reduced.

Preferably, the second hopper is at least partially apex shaped or rectangular shaped or round shaped and/or the first opening of the second hopper builds up a distribution area. The shaped part of the second hopper is preferably in the part of the first opening of the second hopper. The shaped part of the second hopper influences the powder flow. The shaped part is a flow restriction for the powder leaving the second hopper. When using a material (for example powder) with a high friction coefficient the flow restriction caused by the shaped part should be a greater than when using a material with low friction coefficient. The shape of the flow restriction and the used material are therefore adapted to each other in such a way that the powder flow stops when the powder of the second hopper reaches the defined powder level in the first hopper.

If powder leaves the first opening (preferably a letter box shaped opening) of the first hopper and falls on a surface (belt or paper for example), which has a distance of less than 30 mm or preferably less than 2 mm to the first opening of the first hopper, a distributing area of the first hopper is built up.

If powder leaves the first opening of the second hopper and falls on a surface (belt or paper for example), which has a distance of less than 2-10 mm to the first opening of the second hopper, a distributing area of the second hopper is built up.

The distributing area of the second hopper is preferably equal to the area of the first opening of the second hopper. The area, which is refilled by the second hopper, is built up by the dimension of the area of the first opening of the second hopper and the movement of the second hopper along the length of the first opening of the first hopper and is preferably equal to the area of the second opening of the first hopper. “Powder-hills” in the first hopper during or after the refilling can be avoided. It is also possible that the refilled area of the second hopper is a little bit smaller in a direction perpendicular to the movement direction than the area of the second opening of the first hopper.

Preferably, the double hopper system is usable for powder as material. If powder is applied, the friction between the powder particles themselves and between the powder particles and the sidewalls of the hopper system prevents the powder to leave out of the second hopper via the first opening when the first opening of the second hopper is in contact with a defined powder level (or refilled powder level) in the first hopper.

The first opening of the second hopper is preferably arranged at a predetermined (height) distance with respect to the first opening of the first hopper. The second hopper can be arranged relative to the first hopper such that the first opening of the second hopper is just over the second opening of the first hopper. Also, the second hopper may extend into the first hopper.

In a first embodiment, the first hopper is filled first with powder, wherein the powder is filled up to a defined level in the first hopper. Then the second hopper is arranged overhead the first hopper and extends into the first hopper (via the second opening of the first hopper). The second hopper is also filled up with powder, wherein the first opening of the second hopper is in contact with the powder level in the first hopper. At this moment no powder can leave the second hopper due to the powder in the first hopper. So far, as no powder leaves the first hopper (via the first opening of the first hopper), the powder level in the first hopper is constant at defined powder level and no powder flows out of the first opening of the second hopper. If powder leaves the first hopper and the powder level of the first hopper decreases, a gap between the powder level of the first hopper and the first opening of the second hopper arises. Due to this gap powder can flow out of the first opening of the second hopper, and at the same time the second hopper moves simultaneously along the total length of the first hopper. The powder-flow out of the first opening of the second hopper occurs homogeneously over the distribution area of the second hopper. As the defined powder level in the first hopper is restored, no gap between the defined powder level in the first hopper and the first opening of the second hopper exists. The powder-flow of the second hopper then stops.

In a second embodiment, the first hopper is filled with material by the second hopper. This means material, for example powder, is filled into the second hopper via the second opening and fills up the first hopper. While the second hopper fills up the first hopper, the second hopper moves along the length of first opening of the first hopper. If a defined material level in the first hopper is achieved, the second hopper no longer fills up the first hopper and the material remains in the second hopper.

Preferably, the first hopper exhibits a vibrating means. Preferably, the first hopper exhibits a vibrating means in the area of the first opening of the first hopper. Most preferred, the first opening of the first hopper has a “letterbox” design with a letterbox opening and the vibrating means is arranged on this letterbox opening. Preferably, the vibrating means is a vibrating blade.

The letterbox opening is responsible for the volume of material that leaves the first opening of the first hopper. This means that the letterbox opening doses the volume of material that leaves the first opening of the first hopper. Due to the letterbox opening, a powder layer of constant thickness is produced. The aerial weight of the produced powder layer depends on the material level and the powder density in the first hopper. It seems that the unit pressure (or hydrostatic pressure) inside the first hopper is responsible for a homogenously material density, whereby a homogenous unit pressure depends on a homogenous powder level inside the first hopper. Areas with different material levels inside the first hopper have different unit pressures. As a result, different densities of the out coming material occur. Due to this, a homogeneous material level in the first hopper is important when a homogeneous density output of material over a long manufacturing period is desired.

When the volumetric material flow of the first opening of the first hopper is constant, the defined powder level will drop at a constant rate. The refilling process is executed by the movement of the second hopper, which performs a transverse movement with a constant speed. Therefore, the powder level in the first hopper can vary somewhat depending on the material outflow and the traversing speed of the second hopper. The traversing speed of the second hopper must be chosen sufficiently high in order to reduce this effect.

A further aspect of the invention is a method for distributing material using a double hopper system as described above. Preferably, the applied material in the method is a grained material.

The optimal dimensions of the letter box opening of the first hopper and the shaped form of the second hopper depend on the grain size and the internal friction of the powder used. The dimensions of the second hopper, especially the shaped form of the second hopper, are chosen in such a way that the unit pressure at the outlet opening is small but high enough to render free powder flowing without bridge building. The dimensions of the first hopper, especially the letter box part, are chosen in such a way that the unit pressure at the outlet opening is also low, and free flowing of the powder and the static pressure is as little as possible dependent on the filling level.

For the method, the second hopper moves along at least ¾ of the entire length of the first opening of the first hopper during the refilling procedure of the first hopper.

Preferably, the first opening of the second hopper is in contact with the powder of the first hopper when the first hopper has a defined material level. In this case, preferably no material of the second hopper can leave the second hopper via the first opening of the second hopper.

It seems that the grained material in the second hopper cannot leave the first opening of the second hopper due to friction in the contact area between grained material in the first hopper and grained material in the second hopper.

It is further preferred that when material leaves the first hopper via the first opening, the material level of the first hopper is reduced and the first opening of the second hopper loses contact to the material of the first hopper. Material of the second hopper leaves the second hopper via the first opening and enters the first hopper via the second opening of the first hopper.

Preferably, the second hopper moves along the length of the first opening of the first hopper.

Preferably, the second hopper moves continuously along the length of the first opening of the first hopper. This means, the second hopper moves during the refilling process along the length of the first opening of the first hopper and also when the defined powder level is achieved in the first hopper. Preferably a stop of the outflow of the first hopper causes the traversing movement of the second hopper stop. In an especially preferred embodiment, the first and the second hopper runs always during the process.

For better understanding—the first hopper and the second hopper are filled with grained material (like powder), whereby the first hopper has a defined material level and the first opening of the second hopper is arranged in contact with the material of the first hopper such that no material of the second hopper can leave the second hopper via the first opening of the second hopper. If material flows out of the first hopper via the first opening of the first hopper, the defined material level of the first hopper is reduced and the first opening of the second hopper loses contact with the material inside the first hopper. In this case material of the second hopper can leave the second hopper via the first opening of the second hopper and enters the first hopper via the second opening of the first hopper. The first hopper is filled up in this way until the defined material level in the first hopper is restored. Preferably, the second hopper moves during the refilling procedure along the length of the first opening of the first hopper. It is further preferred that the second hopper moves always along the length of the first opening of the first hopper minus the length of the first opening of the second hopper.

It is preferred that the second hopper refills the defined material level by moving once along the length of the first opening of the first hopper. It is further preferred, that the second hopper refills the defined material level by moving along the length of the first opening of the first hopper and back.

Preferably, the material leaves the first opening of the first hopper via gravity. It is further preferred that the material leaves also the first opening of the second hopper via gravity. In these preferred embodiments no additional force is necessary besides gravity and the unit pressure of material arranged above.

Preferably, the material that leaves the first opening of the firsthopper is homogenously distributed on a surface via the vibrating means. This ensures that the powder is flowing easier and differences in powder height and density are minimized, so a layer with constant aerial weight is created. A homogeneous material layer is formed, which has a constant thickness, density and weight per area.

### BRIEF DESCRIPTION OF THE DRAWINGS

The invention is further elucidated by example and figures, which are given below.

FIG. 1 schematically shows a double hopper system.

FIG. 2 schematically shows a second hopper during the refilling procedure.

FIG. 3 schematically shows a part of a first hopper.

FIG. 4 schematically shows a part of a first hopper in detail.

FIG. 5 schematically shows a first and a second hopper.

### DETAILED DESCRIPTION OF THE INVENTION

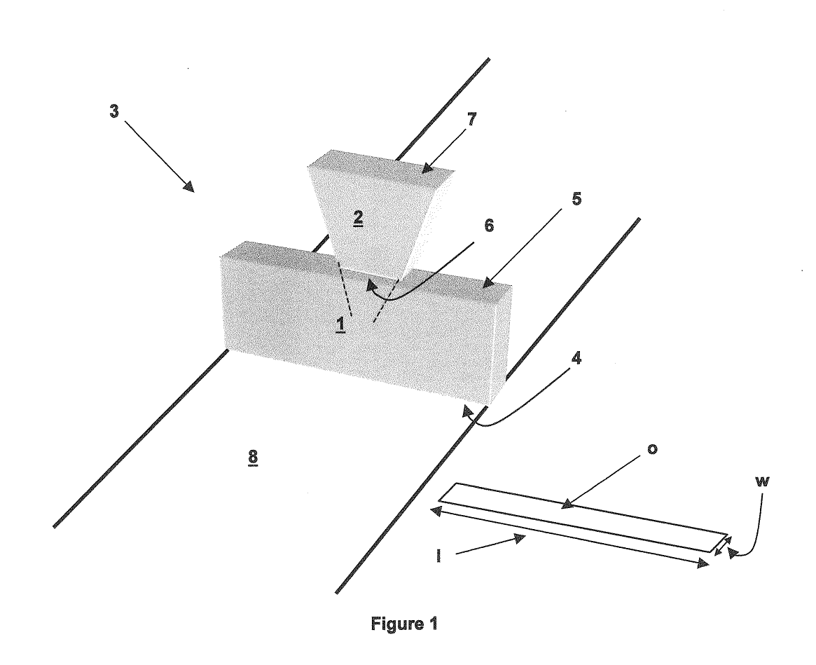

In FIG. 1 a double hopper system 3, comprising at least a first hopper 1 and a second hopper 2 is shown. The first hopper 1 has a first opening 4 and a second opening 5, the second hopper 2 has a first opening 6 and a second opening 7. The second hopper 2 extends partially into the second opening 5 of the first hopper 1. The first opening 4 of the first hopper 1 builds up a distribution area o with a length l and a width w, from which material flows out of the first opening 4 of the first hopper 1. In FIG. 1 this distribution area o is shown at a distance from the hopper system 3 for a clear picture. The dimension of the distributing area o is approximately equal with the area of the first opening 4 of the first hopper 1, wherein the first opening 4 of the first hopper 1 has as a letterbox shaped opening at the front side. The second hopper 2 is moveably arranged with respect to the first hopper 1, whereby the second hopper 2 can move along at least ¾ of the length of l. Preferably, the second hopper 2 moves along l until a side face of the second hopper 2 arrives a side face of the first hopper 1 inside the second opening 5 of the first hopper 1. A belt 8 or paper or foil is arranged below the first opening 4 of the first hopper 1 to collect the material leaving the first hopper 1. The first opening 6 of the second hopper 2 has a width w′ and a length l′, which is approximately equal to the distributing area p (not shown in FIG. 1) of the first opening 6 of the second hopper 2. The shape of the second hopper 2 is optimized in such a way that the powder flows out of the first opening 6 of the second hopper 2 and refills the space that has been created by the decreasing powder level in the first hopper 1. The angle of the sidewalls of the second hopper 2 and the dimension of the first opening 6 of the second hopper 2 depend at least on the flowing behavior of the powder material (e.g., internal friction). This means a shaped part of the second hopper 2 is optimized in such a way that the static pressure is minimal, the powder is free flowing and no bridge formation occurs. The filling level of the second hopper 2 has only little effects in respect to the achieved powder material on the paper. Therefore, refilling the second hopper 2 is less critical and can be done on a continuous or discontinuous basis. Preferably, the second hopper is kept always totally filled.

Preferably, length of the second hopper 2 is approximately equal or a bit smaller than the width b of the second opening of the first hopper. Due to the movement of the second hopper along the length l, the second hopper 2 covers the surface of the second opening 5 of the first hopper 1.

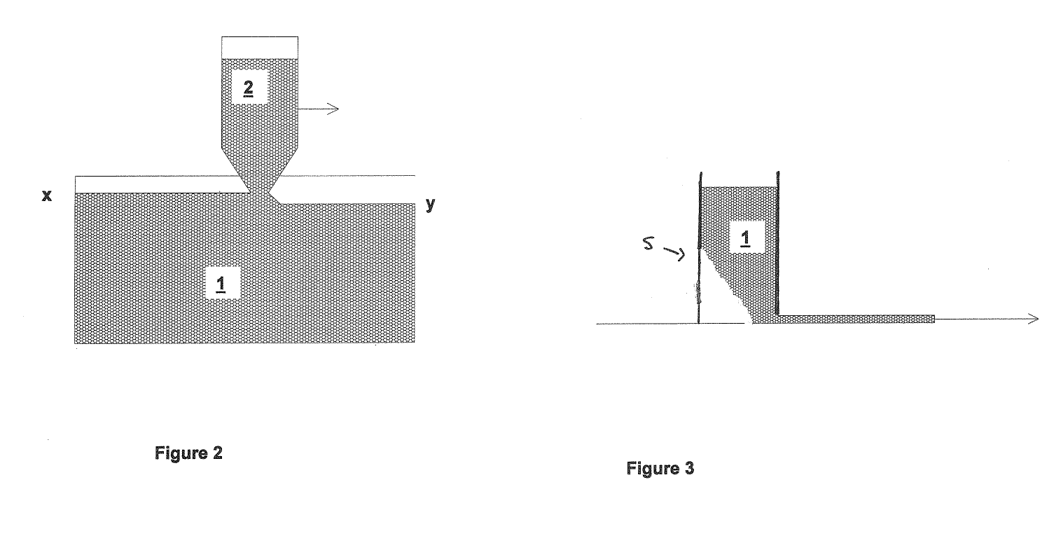

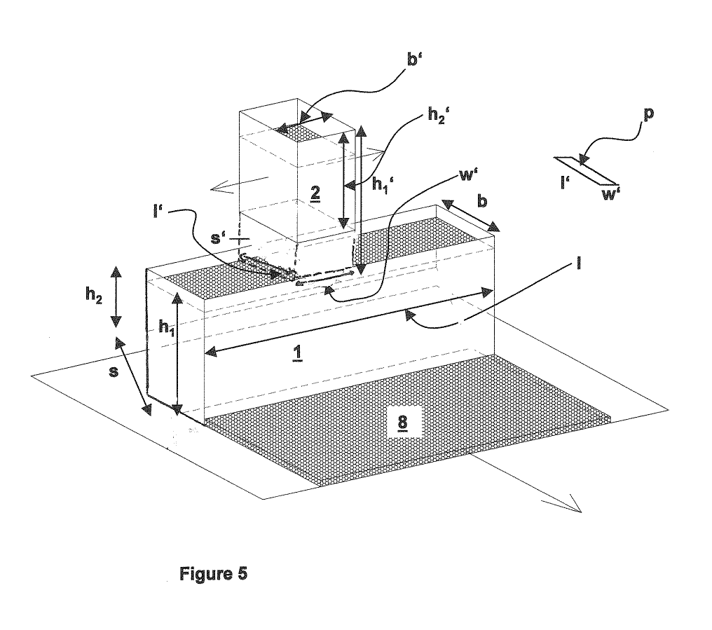

In FIG. 2 a part of the second hopper 2 and the first hopper 1 during the refilling procedure is shown (side-face). The second hopper 2 moves along the length l of the first hopper (in the direction of the arrow in FIG. 2) and material leaves the first opening 6 of the second hopper 2 to fill up the material level y to a defined material level x. If the material level x is restored again, the material of the first hopper 1 is in contact with the first opening 6 of the second hopper 2 so that no material can leave the second hopper 2 via the first opening 6 of the second hopper 2 anymore. The second hopper 2 makes preferably a continuously traversing movement in the length direction l of the first hopper 1 and back, this means perpendicular and preferably horizontal to the production direction (the first hopper 1 makes a movement in production direction in respect to the static belt 8 or the belt 8 makes a move in production direction in respect to the static first hopper 1). The second hopper 2 moves preferably at a constant speed from left to right. When the right side face of the second hopper 2 (or the first opening 6) reaches the right side face of the first hopper 1, the movement stops and it start moving from the right to left again at a constant speed until the left side face of the second hopper 2 (or the first opening 6) reaches the left side face of the first hopper 1. The speed of movement of the second hopper 2 can be coupled to the speed of the moving of the first hopper 1 (or the belt 8), this means on the producing speed. During the production the powder is continuously flowing out of the first opening 4 in letterbox design of the first hopper 1, so that powder level in the first hopper 1 is lowering at a constant rate. A part of the second hopper 2 can be special shaped and comprises the first opening 6 of the second hopper 2. The first opening 6 of the second hopper 2 builds up the distribution area p (see FIG. 5, for a clear picture offset of the first opening 6 of the second hopper 2). The distribution area p has a length of l′ and a width of w′. It is preferred, that the length l′ of the distribution area p is equal or less smaller or approximately equal to the width b of the second opening 5 of the first hopper 1

A third method to start is to fill the first hopper 1 close to the desired level and then use hopper 2 to adjust it exactly to the desired powder level x.

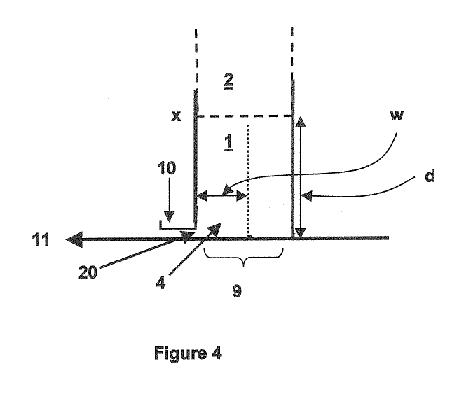

FIG. 3 shows a detail part of the first hopper 1. A surface s is in contact with the belt 8. A material is inside of the first hopper 1, whereby only a part of the material is illustrated. In a preferred embodiment a letterbox opening 20 (20 is part of FIG. 4) is built up.

FIG. 4 shows schematically in detail a part of the first hopper 1 with a part of the second hopper 2 (dashed lines) in side view. The first opening 4 of the first hopper 1 is designed as letterbox 9 with a letterbox opening 20, a surface s and a vibrating blade 10 on the top side. The vibrating blade 10 and the form of the first opening 4 of the first hopper 1 improve a homogenous flowing behavior of the powder. Among other things due to the letterbox opening 20 and the vibrating blade 10 the material can be distributed very homogeneously on the belt 8 in transport direction 11. It should be noted, that the distribution area o could be a bit greater than an area built up by the first opening 4 of the first hopper 1. Due to a distance between first opening 4 of the first hopper 1 and the belt 8 and/or the use of a vibrating means 10, powder could be distributed in distribution area o. The second hopper 2 extends into the second opening 5 of the first hopper 1. If the material level of the first hopper 1 conforms to the defined material level x, the first opening 6 of the second hopper 2 is in contact with the material of the first hopper 1.

In FIG. 5 the first hopper 1 and the second hopper 2 are shown. The second opening 7 of the second hopper 2 has a width b′. The first opening 6 of the second hopper has a width w′ and a length l′, whereby the length l′ of the first opening 6 of the second hopper 2 is approximately equal to or a bit smaller than the width b of the second opening 5 of the first hopper 1. The first hopper 1 has a total height of h₁, which is split into a part h₂ and a surface s. Due to the angular part s the width w of the first opening 4 of the first hopper 1 is different from the width b of the second opening 5 of the first hopper 1.

### REFERENCE NUMBERS

1 first hopper
2 second hopper
3 double hopper system
4 first opening, first hopper
5 second opening, first hopper
6 first opening, second hopper
7 second opening, first hopper
8 belt
9 letterbox
10 vibrating means
11 transport direction
20 letterbox opening
l length, distribution area o
w width, distribution area o
o distribution area, build up by the first opening of the first hopper
l′ length, distribution area p
w′ width, distribution area p
p distribution area, build up by the first opening of the second hopper
x defined material level
y (actually) material level
d distance
s surface (first hopper)
s′ shaped part (second hopper)
b width of the second opening of the first hopper
b′ width of the second opening of the second hopper
h₁ total height of the first hopper
h₂ cuboids part of the first hopper
h₁′ total height of the second hopper
h₂′ cuboids part of the second hopper

1. A double hopper system, the system comprising:
a first hopper having a first opening and a second opening; and
a second hopper being arranged above the second opening of the first hopper, extending into the second opening of the first hopper, and being moveably arranged with respect to the first hopper,
wherein the second hopper is moveable over at least ¾ of a length of the first opening of the first hopper.

2. The double hopper system according to claim 1, wherein a distribution area is built up by the first opening of the first hopper.

3. The double hopper system according to claim 2, wherein the second hopper is moveably arranged with respect to the first hopper such that the second hopper is movable in a plane parallel to the distribution area.

4. The double hopper system according to claim 2, wherein the second hopper is moveably arranged such that the second hopper is movable horizontally only.

5. The double hopper system according to claim 1, wherein the second hopper has a first opening, a distribution area of the second hopper being built up by the first opening of the second hopper.

6. The double hopper system according to claim 1, wherein the second hopper has a flow restriction.

7. The double hopper system according to claim 6, wherein the flow restriction is a result of a partially apex-shaped, rectangular-shaped, or triangular-shaped form of the second hopper.

8. The double hopper system according to claim 5, wherein the first opening of the second hopper is arranged at a predetermined distance from the first opening of the first hopper.

9. The double hopper system according to claim 1, wherein the first hopper has a vibrating device on one side face of the first opening of the first hopper.

10. The double hopper system according to claim 1, wherein the second hopper moves along the at least ¾ of the length of the first opening of the first hopper during refill of the first hopper.

11. The double hopper system according to claim 5, wherein, when material in the first hopper is at a defined material level such that the first opening of the second hopper is in contact with the material of the first hopper, no material of the second hopper can leave the second hopper via the first opening of the second hopper.

12. The double hopper system according to claim 11, wherein when (1) the material leaves the first hopper via the first opening of the first hopper, (2) the material in the first hopper is reduced below the defined material level, and (3) the first opening of the second hopper loses contact with the material in the first hopper, material in the second hopper leaves the second hopper via the first opening of the second hopping and enters the first hopper via the second opening of the first hopper.

13. The double hopper system according to claim 11, wherein the second hopper moves along the length of the first opening of the first hopper until the defined material level is restored.

14. The double hopper system according to claim 11, wherein the second hopper moves continuously along the length of the first opening of the first hopper.

15. A method for distributing material using the double hopper system of claim 1, the method comprising:
moving the second hopper along the at least ¾ of the length of the first opening of the first hopper during a refilling of the first hopper.

16. A method for distributing material using the double hopper system of claim 12, the method comprising:
distributing the material via the first opening of the first hopper; and
refilling the first hopper with the material from the second hopper that leaves the second hopper via the first opening of the second hopper and enters the first hopper via the second opening of the first hopper, the refilling occurring when the material in the first hopper is reduced below the defined material level and the first opening of the second hopper loses contact with the material in the first hopper.

17. A method for distributing material using the double hopper system of claim 11, the method comprising:
moving the second hopper along the at least ¾ of the length of the first opening of the first hopper during a refilling of the first hopper until the defined material level is restored.

18. A method for distributing material using the double hopper system of claim 11, the method comprising:
moving the second hopper along the at least ¾ of the length of the first opening of the first hopper, the moving of the second hopper being continuous.
